(19) United States
(12) Patent Application Publication
(10) Pub. No.: US 2024/0201466 A1
(43) Pub. Date: Jun. 20, 2024

(54) BARREL-LESS COMPACT CAMERA DEVICE WITH MICROMOLDING LENS STACK

(71) Applicant: Meta Platforms Technologies, LLC, Menlo Park, CA (US)

(72) Inventors: Amber Sun, Sunnyvale, CA (US); Kee Siang Goh, Singapore (SG)

(21) Appl. No.: 18/379,041

(22) Filed: Oct. 11, 2023

Related U.S. Application Data
(60) Provisional application No. 63/433,910, filed on Dec. 20, 2022.

(51) Int. Cl. G02B 7/02

(52) U.S. Cl. CPC G02B 7/021

(57) ABSTRACT

A compact camera device with a lens assembly that does not include any lens barrel or lens holder. The lens assembly includes a first micromolding lens and a second micromolding lens. The first micromolding lens includes a first side and a second side that is opposite to the first side, the first side including a first mounting surface. The second micromolding lens includes a third side and a fourth side that is opposite to the third side, the fourth side including a second mounting surface that is directly affixed to the first mounting surface to form at least a portion of a micromolding lens stack comprising the first micromolding lens and the second micromolding lens in optical series. The micromolding lens stack is a self-supporting structure fixed in place within the camera device without the use of a lens barrel or a lens holder.

### CROSS REFERENCE TO RELATED APPLICATIONS

This application claims a priority and benefit to U.S. Provisional Patent Application Ser. No. 63/433,910, filed Dec. 20, 2022, which is hereby incorporated by reference in its entirety.

### FIELD OF THE INVENTION

The present disclosure relates generally to a compact camera device, and specifically relates to a barrel-less compact camera device with a micromolding lens stack.

BACKGROUND

Current camera miniaturization technology has two main trends in relation to a process of integrating a lens assembly with multiple lenses into a camera device: wafer-level optics (WLO) and micromolding. The WLO lens technology has the advantage of assembling a camera device with a relatively small form factor, whereas the micromolding technology has the advantage of assembling a camera device with reduced z-height (i.e., vertical dimension). These two main features of the WLO lens technology and the micromolding technology are mutually exclusive. Additionally, the WLO lens technology is more limited in relation to lens shapes compared to the micromolding technology because of the WLO process limitation.

The current WLO lens technology has two lens implementation alternatives, i.e., the paddle-type WLO lens implementation and the casting-type WLO lens implementation. In particular, the paddle-type WLO lens implementation technology may result in more complex shaped lenses by combining the lenses with more glass substrates added for usage in different applications and for achieving a small footprint. For example, a bandpass filter can be coated on one of the glass substrates without the need for separate pieces of glass. However, a camera device implemented using the paddle-type WLO lens implementation technology features a baseline z-height that corresponds to a sum of thicknesses of glass substrates. Hence, the camera device based on the paddle-type WLO lens implementation technology has less options in relation to lens materials for achieving better optical performance, such as higher sharpness and lower thermal shift. On the other hand, the casting-type WLO lens implementation technology does not require glass substrates. However, the casting-type WLO lens implementation technology requires a wider lens footprint for achieving the self-support of a stable camera device structure, which is against the requirement to keep the small footprint of the camera device.

The current micromolding lens technology has two lens implementation alternatives, i.e., the single piece micromolding freeform lens implementation and the micromolding lens stack implementation. A z-height of the micromolding lens stack comes only from the lens and tiny lens spacers, and the micromolding lens stack implementation has more options in relation to the lens materials to achieve better optical performance (e.g., higher sharpness and lower thermal shift) in comparison with the WLO lens technology. However, both the single piece micromolding freeform lens implementation and the micromolding lens stack implementation require assembling the lenses in a barrel or a lens holder, which increases the footprint of the camera device due to the barrel/lens holder thickness.

### SUMMARY

Embodiments of the present disclosure relate to a camera device (e.g., wearable camera device) with a lens assembly that does not include any lens barrel or lens holder. The lens assembly includes a first micromolding lens and a second micromolding lens. The first micromolding lens includes a first side and a second side that is opposite to the first side, the first side including a first mounting surface. The second micromolding lens includes a third side and a fourth side that is opposite to the third side, the fourth side including a second mounting surface that is directly affixed to the first mounting surface to form at least a portion of a micromolding lens stack comprising the first micromolding lens and the second micromolding lens in optical series. The micromolding lens stack is a self-supporting structure fixed in place within the camera device without the use of a lens barrel or a lens holder.

The camera device presented herein may be part of a wristband system, e.g., a smartwatch or some other electronic wearable device. Additionally or alternatively, the camera device presented herein may be part of a handheld electronic device (e.g., smartphone) or some other portable electronic device (e.g., headset, smart glasses, etc.). Additionally or alternatively, the camera device presented herein may be part of a dashboard camera device.

### BRIEF DESCRIPTION OF THE DRAWINGS

FIG. 1A is a top view of an example wristband system, in accordance with one or more embodiments.

FIG. 1B is a side view of the example wristband system of FIG. 1A.

FIG. 2A is a perspective view of another example wristband system, in accordance with one or more embodiments.

FIG. 2B is a perspective view of the example wristband system of FIG. 2A with a watch body released from a watch band, in accordance with one or more embodiments.

FIGS. 3A-3B are diagrams of head-mounted displays (HMDs) that include near-eye displays (NEDs), in accordance with one or more embodiments.

FIG. 4A is a first example cross section of a camera device in an upward (vertical) posture, in accordance with one or more embodiments.

FIG. 4B is a second example cross section of a camera device in an upward posture, in accordance with one or more embodiments.

FIG. 4C is a third example cross section of a camera device in an upward posture, in accordance with one or more embodiments.

FIG. 5 is an example cross section of a barrel-less camera device in an upward posture, in accordance with one or more embodiments.

FIG. 6 is a flowchart illustrating a process of assembling a camera device without use of a barrel or lens holder, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Embodiments of the present disclosure relate to a camera device (e.g., wearable camera device) with a micromolding lens assembly. The micromolding lens assembly may include a plurality of micromolding optical elements (e.g., micromolding lenses) that are in optical series forming a micromolding lens stack (i.e., single molding lenses). Each micromolding optical element may be directly affixed (e.g., via an interlocking mechanism, and optionally, via an adhesive) to adjacent micromolding optical elements without the use of a lens barrel or a lens holder.

In one or more embodiments, the micromolding lens stack is assembled by applying the active alignment technology, and by applying protective coating of one or more layers on an external wall of the micromolding lens stack. In one or more other embodiments, the micromolding lens stack is assembled by utilizing features at micromolding lens flanges so that the micromolding lenses within the micromolding lens stack can be aligned and stacked together. In one or more other embodiments, an interlock structure incorporated in a flange of one or more corresponding micromolding lenses is used to directly affix the micromolding lenses and achieve self-aligning of the micromolding lenses within the micromolding lens stack. Additionally, an adhesive (e.g., glue) may be applied to further enhance the interlock structure. In each of these cases, as the micromolding lenses are stacked using the features incorporated at micromolding lens flanges, the micromolding lens stack may be assembled and aligned without the use of a lens barrel or a lens holder.

The camera device assembled in this manner can have advantages in comparison with both the WLO lens technology and the micromolding lens technology, i.e., the camera device presented herein may feature both a small footprint size of the lens assembly and a short z-height of the lens assembly, which facilitates implementation of the compact and high image quality camera device.

The camera device presented herein may be incorporated into a small form factor electronic device, such as an electronic wearable device, or a dashboard camera device. Examples of electronic wearable devices include a smartwatch, near-eye-display (NED), a head-mount display (HMD), or a smartphone. The electronic device can include other components (e.g., haptic devices, speakers, etc.). And, the small form factor of the electronic device provides limited space between the other components and the camera device. In some embodiments, the electronic device may have limited power supply (e.g., due to being dependent on a rechargeable battery).

In some embodiments, the electronic wearable device may operate in an artificial reality environment (e.g., a virtual reality environment). The camera device of the electronic wearable device may be used to enhance an artificial reality application running on an artificial reality system (e.g., running on an HMD device or NED device worn by the user). The camera device may be disposed on multiple surfaces of the electronic wearable device such that data from a local area, e.g., surrounding a wrist of the user, may be captured in multiple directions. For example, one or more images may be captured describing the local area and the images may be sent and processed by the HMD (or the NED) prior to be presented to the user.

Embodiments of the present disclosure may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including an electronic wearable device (e.g., headset) connected to a host computer system, a standalone electronic wearable device (e.g., headset, NED, smart glasses, smartwatch, bracelet, etc.), a mobile device or computing system, or any other hardware platform capable of providing artificial reality content to one or more viewers.

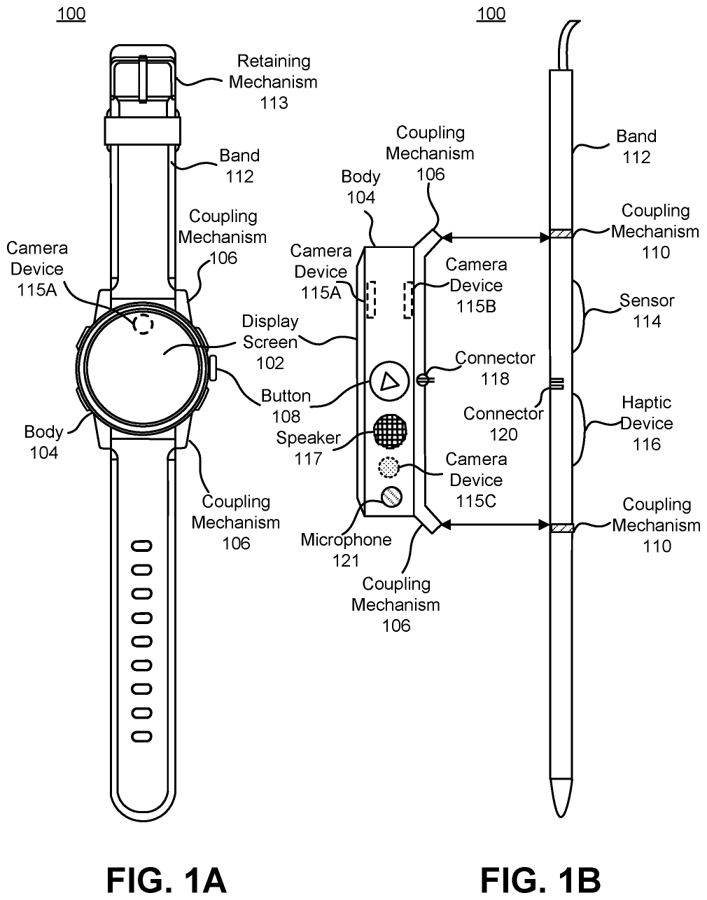

FIG. 1A is a top view of an example wristband system 100, in accordance with one or more embodiments. FIG. 1B is a side view of the example wristband system 100 of FIG. 1A. The wristband system 100 is an electronic wearable device and may be worn on a wrist or an arm of a user. In some embodiments, the wristband system 100 is a smartwatch. Media content may be presented to the user wearing the wristband system 100 using a display screen 102 and/or one or more speakers 117. However, the wristband system 100 may also be used such that media content is presented to a user in a different manner (e.g., via touch utilizing a haptic device 116). Examples of media content presented by the wristband system 100 include one or more images, video, audio, or some combination thereof. The wristband system 100 may operate in an artificial reality environment (e.g., a VR environment, an AR environment, a MR environment, or some combination thereof).

In some examples, the wristband system 100 may include multiple electronic devices (not shown) including, without limitation, a smartphone, a server, a head-mounted display (HMD), a laptop computer, a desktop computer, a gaming system, Internet of things devices, etc. Such electronic devices may communicate with the wristband system 100 (e.g., via a personal area network). The wristband system 100 may have sufficient processing capabilities (e.g., central processing unit (CPU), memory, bandwidth, battery power, etc.) to offload computing tasks from each of the multiple electronic devices to the wristband system 100. Additionally, or alternatively, each of the multiple electronic devices may have sufficient processing capabilities (e.g., CPU, memory, bandwidth, battery power, etc.) to offload computing tasks from the wristband system 100 to the electronic device(s).

The wristband system 100 includes a watch body 104 coupled to a watch band 112 via one or more coupling mechanisms 106, 110. The watch body 104 may include, among other components, one or more coupling mechanisms 106, one or more camera devices 115 (e.g., camera device 115A, camera device 115B and/or camera device 115C), the display screen 102, a button 108, a connector 118, a speaker 117, and a microphone 121. The watch band 112 may include, among other components, one or more coupling mechanisms 110, a retaining mechanism 113, one or more sensors 114, the haptic device 116, and a connector 120. While FIGS. 1A and 1B illustrate the components of the wristband system 100 in example locations on the wristband system 100, the components may be located elsewhere on the wristband system 100, on a peripheral electronic device paired with the wristband system 100, or some combination thereof. Similarly, there may be more or fewer components on the wristband system 100 than what is shown in FIGS. 1A and 1B. For example, in some embodiments, the watch body 104 may include a port for connecting the wristband system 100 to a peripheral electronic device and/or to a power source. The port may enable charging of a battery of the wristband system 100 and/or communication between the wristband system 100 and a peripheral device. In another example, the watch body 104 may include an inertial measurement unit (IMU) that measures a change in position, an orientation, and/or an acceleration of the wristband system 100. The IMU may include one or more sensors, such as one or more accelerometers, one or more gyroscopes, one or more magnetometers, another suitable type of sensor that detects motion, a type of sensor used for error correction of the IMU, or some combination thereof.

The watch body 104 and the watch band 112 may have any size and/or shape that is configured to allow a user to wear the wristband system 100 on a body part (e.g., a wrist). The wristband system 100 may include the retaining mechanism 113 (e.g., a buckle) for securing the watch band 112 to the wrist of the user. The coupling mechanism 106 of the watch body 104 and the coupling mechanism 110 of the watch band 112 may attach the watch body 104 to the watch band 112. For example, the coupling mechanism 106 may couple with the coupling mechanism 110 by sticking to, attaching to, fastening to, affixing to, some other suitable means for coupling to, or some combination thereof.

The wristband system 100 may perform various functions associated with the user. The functions may be executed independently in the watch body 104, independently in the watch band 112, and/or in communication between the watch body 104 and the watch band 112. In some embodiments, a user may select a function by interacting with the button 108 (e.g., by pushing, turning, etc.). In some embodiments, a user may select a function by interacting with the display screen 102. For example, the display screen 102 is a touchscreen and the user may select a particular function by touching the display screen 102. The functions executed by the wristband system 100 may include, without limitation, displaying visual content to the user (e.g., displaying visual content on the display screen 102), presenting audio content to the user (e.g., presenting audio content via the speaker 117), sensing user input (e.g., sensing a touch of button 108, sensing biometric data with the one or more sensors 114, sensing neuromuscular signals with the one or more sensors 114, etc.), capturing audio content (e.g., capturing audio with microphone 121), capturing data describing a local area (e.g., with a front-facing camera device 115A, a rear-facing camera device 115B and/or a side-facing camera device 115C), communicating wirelessly (e.g., via cellular, near field, Wi-Fi, personal area network, etc.), communicating via wire (e.g., via the port), determining location (e.g., sensing position data with a sensor 114), determining a change in position (e.g., sensing change(s) in position with an IMU), determining an orientation and/or acceleration (e.g., sensing orientation and/or acceleration data with an IMU), providing haptic feedback (e.g., with the haptic device 116), etc.

The display screen 102 may display visual content to the user. The displayed visual content may be oriented to the eye gaze of the user such that the content is easily viewed by the user. Traditional displays on wristband systems may orient the visual content in a static manner such that when a user moves or rotates the wristband system, the content may remain in the same position relative to the wristband system causing difficulty for the user to view the content. The displayed visual content may be oriented (e.g., rotated, flipped, stretched, etc.) such that the displayed content remains in substantially the same orientation relative to the eye gaze of the user (e.g., the direction in which the user is looking). The displayed visual content may also be modified based on the eye gaze of the user. For example, in order to reduce the power consumption of the wristband system 100, the display screen 102 may dim the brightness of the displayed visual content, pause the displaying of visual content, or power down the display screen 102 when it is determined that the user is not looking at the display screen 102. In some examples, one or more sensors 114 of the wristband system 100 may determine an orientation of the display screen 102 relative to an eye gaze direction of the user.

The position, orientation, and/or motion of eyes of the user may be measured in a variety of ways, including through the use of optical-based eye-tracking techniques, infrared-based eye-tracking techniques, etc. For example, the front-facing camera device 115A, the rear-facing camera device 115B and/or the side-facing camera device 115C may capture data (e.g., visible light, infrared light, etc.) of the local area surrounding the wristband system 100 including the eyes of the user. The captured data may be processed by a controller (not shown) internal to the wristband system 100, a controller external to and in communication with the wristband system 100 (e.g., a controller of an HMD), or a combination thereof to determine the eye gaze direction of the user. The display screen 102 may receive the determined eye gaze direction and orient the displayed content based on the eye gaze direction of the user.

In some embodiments, the watch body 104 may be communicatively coupled to an HMD. The front-facing camera device 115A, the rear-facing camera device 115B and/or the side-facing camera device 115C may capture data describing the local area, such as one or more wide-angle images of the local area surrounding the front-facing camera device 115A, the rear-facing camera device 115B and/or the side-facing camera device 115C. The wide-angle images may include hemispherical images (e.g., at least hemispherical, substantially spherical, etc.), 180-degree images, 360-degree area images, panoramic images, ultra-wide area images, or a combination thereof. In some examples, the front-facing camera device 115A and/or the rear-facing camera device 115B may be configured to capture images having a range between 45 degrees and 360 degrees. The captured data may be communicated to the HMD and displayed to the user on a display screen of the HMD worn by the user. In some examples, the captured data may be displayed to the user in conjunction with an artificial reality application. In some embodiments, images captured by the front-facing camera device 115A, the rear-facing camera device 115B and/or the side-facing camera device 115C may be processed before being displayed on the HMD. For example, certain features and/or objects (e.g., people, faces, devices, backgrounds, etc.) of the captured data may be subtracted, added, and/or enhanced before displaying on the HMD.

Components of the front-facing camera device 115A, the rear-facing camera device 115B and/or the side-facing camera device 115C may be capable of taking pictures capturing data describing the local area. A lens assembly of the front-facing camera device 115A, a lens assembly of the rear-facing camera device 115B and/or a lens assembly of the side-facing camera device 115C can be automatically positioned at their target positions. A target position in a forward (or horizontal) posture of the front-facing camera device 115A may correspond to a position at which the lens assembly of the front-facing camera device 115A is focused at a preferred focal distance (e.g., distance in the order of several decimeters). A target position in a forward (or horizontal) posture of the rear-facing camera device 115B may correspond to a position at which the lens assembly of the rear-facing camera device 115B is focused at a hyperfocal distance in the local area (e.g., a distance of approximately 1.7 meter). A target position in a forward (or horizontal) posture of the side-facing camera device 115C may correspond to a position at which the lens assembly of the side-facing camera device 115C is focused at a preferred focal distance (e.g., distance in the order of several decimeters or the hyperfocal distance). An upward (vertical) posture of the front-facing camera device 115A (or the rear-facing camera device 115B, or the side-facing camera device 115C) corresponds to a posture where an optical axis is substantially parallel to gravity. And a forward (horizontal) posture of the front-facing camera device 115A (or the rear-facing camera device 115B, or the side-facing camera device 115C) corresponds to a posture when the optical axis is substantially orthogonal to gravity.

When the front-facing camera device 115A (or the rear-facing camera device 115B, or the or the side-facing camera device 115C) changes its posture from, e.g., an upward posture to a forward posture, optical image stabilization (OIS) and/or focusing may be applied by allowing a certain amount of shift (i.e., stroke) of a sensor of the front-facing camera device 115A (or the rear-facing camera device 115B, or the side-facing camera device 115C) along at least one spatial direction.

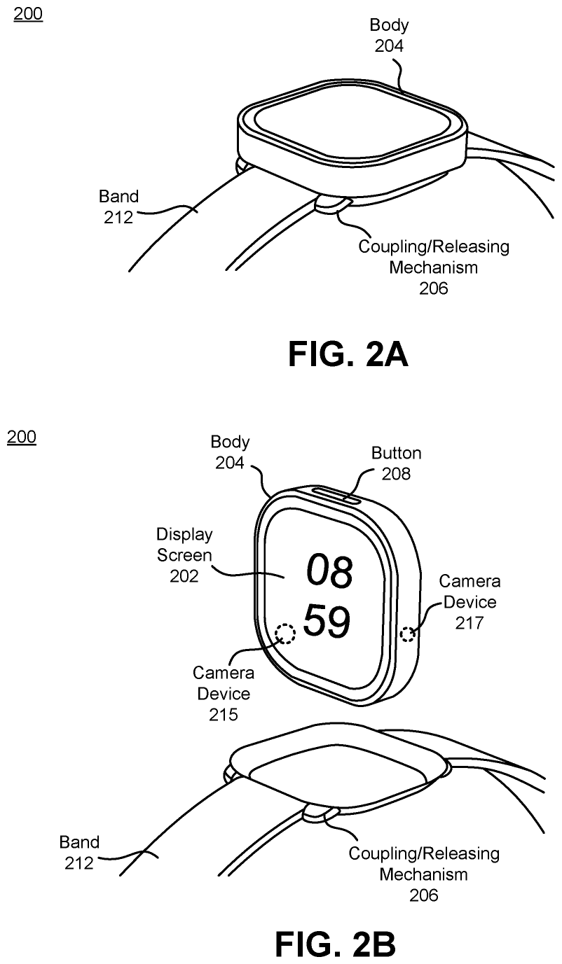

FIG. 2A is a perspective view of another example wristband system 200, in accordance with one or more embodiments. The wristband system 200 includes many of the same components described above with reference to FIGS. 1A and 1B, but a design or layout of the components may be modified to integrate with a different form factor. For example, the wristband system 200 includes a watch body 204 and a watch band 212 of different shapes and with different layouts of components compared to the watch body 104 and the watch band 112 of the wristband system 100. FIG. 2A further illustrates a coupling/releasing mechanism 206 for coupling/releasing the watch body 204 to/from the watch band 212.

FIG. 2B is a perspective view of the example wristband system 200 with the watch body 204 released from the watch band 212, in accordance with one or more embodiments. FIG. 2B further illustrates a camera device 215, a camera device 217, a display screen 202, and a button 208. In some embodiments, another camera device may be located on an underside of the watch body 204 and is not shown in FIG. 2B. In some embodiments (not shown in FIGS. 2A-2B), one or more sensors, a speaker, a microphone, a haptic device, a retaining mechanism, etc. may be included on the watch body 204 or the watch band 212. As the wristband system 100 and the wristband system 200 are of a small form factor to be easily and comfortably worn on a wrist of a user, the corresponding camera devices 115, 215, 217 and various other components of the wristband system 100 and the wristband system 200 described above are designed to be of an even smaller form factor and are positioned close to each other. In some embodiments, one of the camera devices 215 and 217 is not included in the wristband system 200.

When the camera device 215 (or the camera device 217) changes its posture, e.g., from an upward posture to a forward posture, OIS and focusing may be applied by allowing a certain amount of shift (i.e., stroke) of a sensor of the camera device 215 (or the camera device 217) along at least one spatial direction. Ranges of strokes may be asymmetric for the orthogonal spatial directions, i.e., an amount of shift along a first direction may be different than an amount of shift along a second direction orthogonal to the first direction. For example, a shifting range in a direction where more motion of the camera device 215 (or the camera device 217) is expected (e.g., vertical direction) may be longer than a shifting range in the orthogonal direction (e.g., horizontal direction).

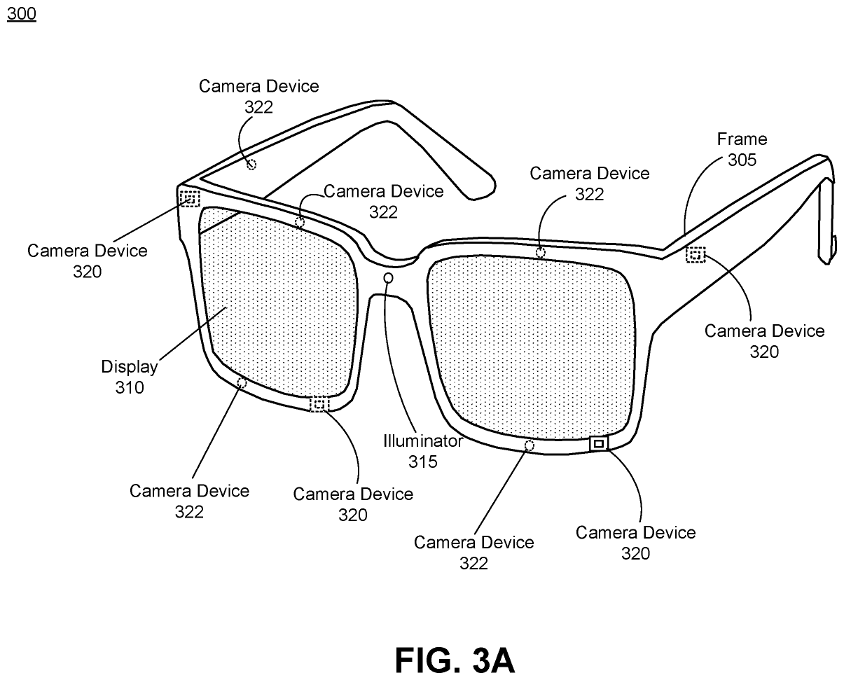

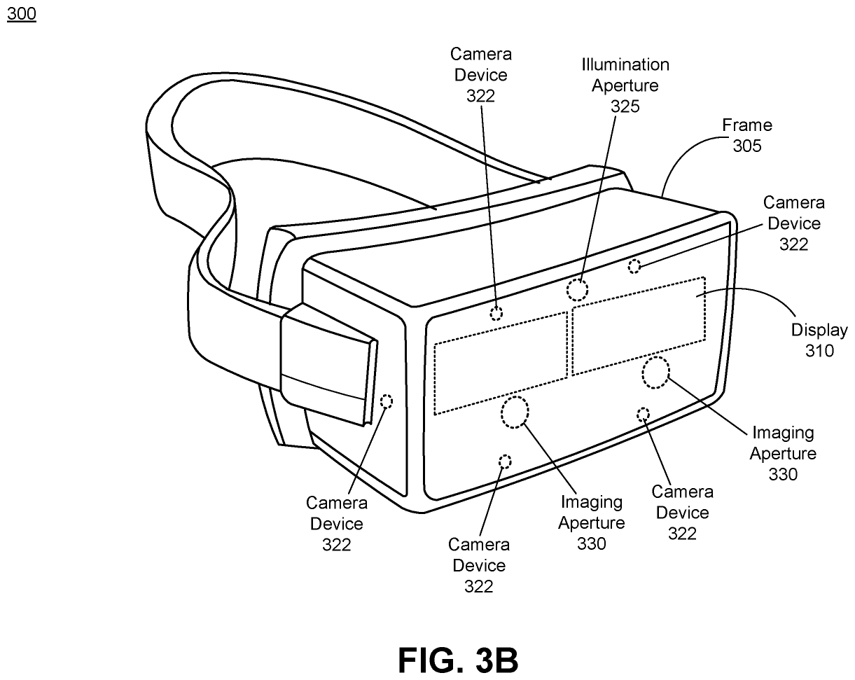

FIGS. 3A and 3B are diagrams of head-mounted displays (HMDs) 300 that include near-eye displays (NEDs), in accordance with one or more embodiments. The NED (or smart glasses) may present media to a user. Examples of media that may be presented by the NED include one or more images, video, audio, or some combination thereof. In some embodiments, audio may be presented via an external device (e.g., speakers and/or headphones) that receives audio information from the HMD 300, a console (not shown), or both, and presents audio data to the user based on the audio information. The HMD 300 is generally configured to operate as a VR HMD. However, in some embodiments, the HMD 300 may be modified to also operate as an AR HMD, a MR HMD, or some combination thereof. For example, in some embodiments, the HMD 300 may augment views of a physical, real-world environment with computer-generated elements (e.g., still images, video, sound, etc.).

The HMD 300 shown in FIG. 3A or FIG. 3B may include a frame 305 and a display 310. The frame 305 may include one or more optical elements that together display media to a user. That is, the display 310 may be configured for a user to view the content presented by the HMD 300. The display 310 may include at least one light source assembly to generate image light to present optical media to an eye of the user. The light source assembly may include, e.g., a light source, an optics system, or some combination thereof.

The HMD 300 shown in FIG. 3A may further include an illuminator 315, one or more camera devices 320, and one or more camera devices 322. The illuminator 315 and the one or more camera devices 320 may be part of a depth camera assembly (DCA) configured to determine depth information for a portion of a local area surrounding the HMD 300 (i.e., for one or more objects in the local area). The DCA may further include a DCA controller coupled to at least one of the illuminator 315 and the camera device 320 (not shown in FIGS. 3A-3B). In some embodiments, the illuminator 315 and the camera device 320 each may include its own internal controller. In some embodiments, the illuminator 315 and the camera device 320 can be widely separated, e.g., the illuminator 315 and the camera device 320 can be located in different assemblies.

The illuminator 315 may be configured to illuminate the local area with light in accordance with emission instructions generated by the DCA controller. The illuminator 315 may include an array of emitters, and at least a portion of the emitters in the array emit light simultaneously. In one or more embodiments, the illuminator 315 includes one or more arrays of vertical surface emitting lasers (VCSELs). At least the portion of the emitters in the array of the illuminator 315 may emit light in a near infra-red (NIR) spectrum, e.g., having one or more wavelengths between approximately 780 nm and 2500 nm. The emitted NIR light may be then projected into the scene by a projection lens of the illuminator 315. In one or more embodiments, the illuminator 315 illuminates a portion of a local area with light. The light may be, e.g., structured light (e.g., dot pattern, bars, etc.) in the infrared (IR), IR flash for time-of-flight (ToF), etc. The illuminator 315 can be implemented as a versatile and yet power efficient NIR illuminator, which can be utilized with most depth sensing techniques, such as direct time-of-flight (dToF) depth sensing, indirect time-of-flight (iToF) depth sensing, structured light depth sensing, active stereo vision depth sensing, hybrid depth sensing combining structured light depth sensing and ToF based depth sensing, etc.

The camera device 320 may be configured to capture one or more images of at least a portion of the light reflected from one or more objects in the local area. In one or more embodiments, the camera device 320 captures images of a portion of the local area that includes the light from the illuminator 315. In some embodiments, one or more light sources are integrated into the camera device 320, and the illuminator 315 is not included in the HMD 300. In such cases, the one or more light sources may be, e.g., mounted on a glass frame of a sensor of the camera device 320 or otherwise placed in a vicinity of the sensor so that an illumination area of the at least one light source substantially overlaps with a field of view of the camera device 320. In one embodiment, the camera device 320 is an infrared camera configured to capture images in an IR spectrum and/or a NIR spectrum. Additionally, the camera device 320 may be also configured to capture images of visible spectrum light. The camera device 320 may include a charge-coupled device (CCD) sensor, a complementary metal-oxide-semiconductor (CMOS) sensor, or some other type of sensor. The camera device 320 may be configured to operate with a frame rate in the range of approximately 30 Hz to approximately 1 KHz for fast detection of objects in the local area. In some embodiments, the camera device 320 is deactivated for a defined amount of time before being activated again. Alternatively or additionally, the camera device 320 can operate as instructed by the DCA controller for single or multiple frames, up to a maximum frame rate, which can be in the kilohertz range. The one or more camera devices 320 may be part of a simultaneous localization and mapping (SLAM) sensor array mounted on the HMD 300 for capturing visual information of a local area surrounding some or all of the HMD 300.

The DCA controller may generate emission instructions and provide the emission instructions to the illuminator 315 for controlling operation of at least a portion of emitters in the emitter array in the illuminator 315 to emit light. The DCA controller may be also configured to determine depth information for the one or more objects in the local area based in part on the one or more images captured by the camera device 320. The DCA controller may compute the depth information using one or more depth determination techniques. The depth determination technique may be, e.g., dToF depth sensing, iToF depth sensing, structured light, passive stereo analysis, active stereo analysis (uses texture added to the scene by light from the illuminator 315), some other technique to determine depth of a scene, or some combination thereof. In some embodiments, the DCA controller provides the determined depth information to a console (not shown in FIGS. 3A-3B) and/or an appropriate module of the HMD 300 (e.g., a varifocal module, not shown in FIGS. 3A-3B). The console and/or the HMD 300 may utilize the depth information to, e.g., generate content for presentation on the display 310.

The one or more camera devices 322 may be configured for eye tracking, i.e., to capture light reflected from one or more surfaces of one or both eyes of the user wearing the HMD 300. Alternatively or additionally, the one or more camera devices 322 may be configured for face tracking (e.g., upper face tracking and/or lower face tracking), i.e., to capture light reflected from one or more portions of a face of the user wearing the HMD 300. The camera device 322 may be an infrared camera configured to capture images in the IR spectrum and/or the NIR spectrum. The camera device 322 may include a CCD sensor, a CMOS sensor, or some other type of sensor. In some embodiments, the camera device 322 is deactivated for a defined amount of time before being activated again.

The HMD 300 shown in FIG. 3B may further include an illumination aperture 325 associated with the illuminator 315, and one or more imaging apertures 330 associated with the one or more camera devices 320. The illuminator 315 may emit light (e.g., a structured light pattern) through the illumination aperture 325. The one or more camera devices 320 may capture light that is reflected from the local area through at least one of the imaging apertures 330. The one or more imaging apertures 330 may be associated with the one or more camera devices 320 that are part of a SLAM sensor array. As described above in relation to FIG. 3A, the one or more camera devices 322 may be configured for eye tracking and/or face tracking (upper face tracking and/or lower face tracking).

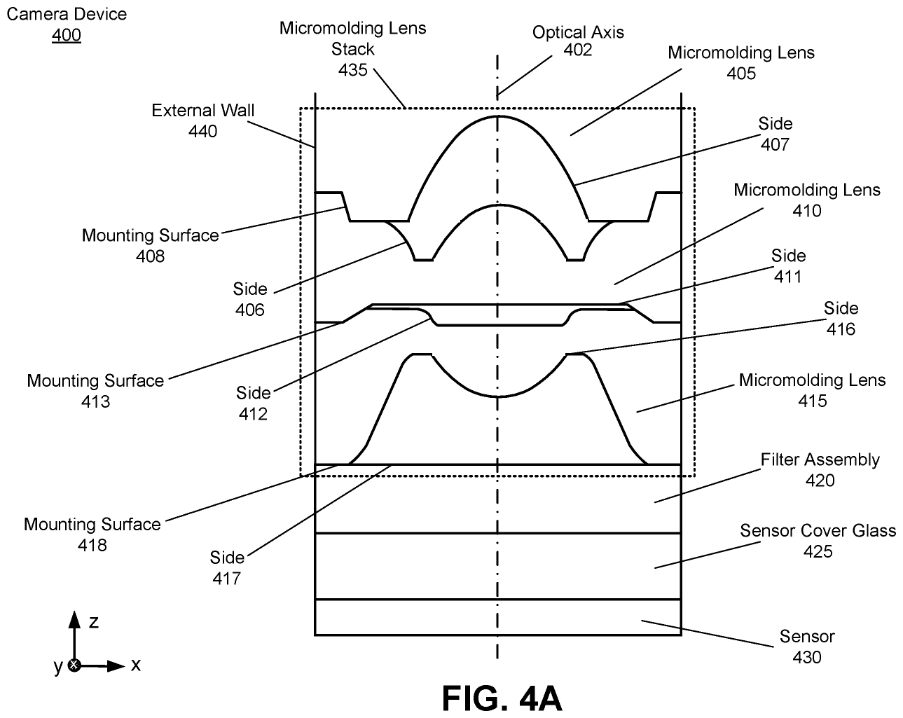

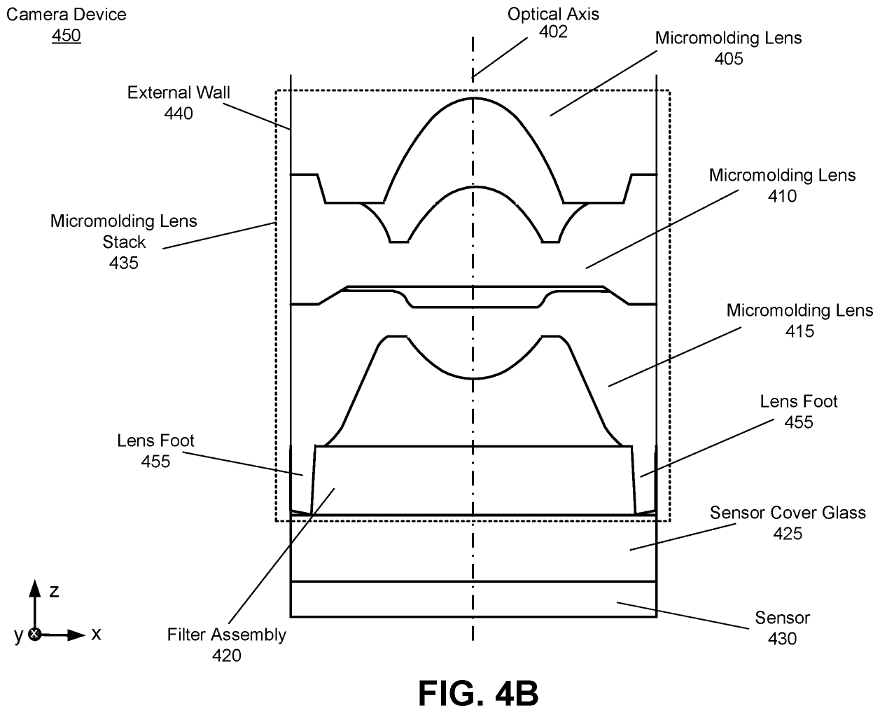

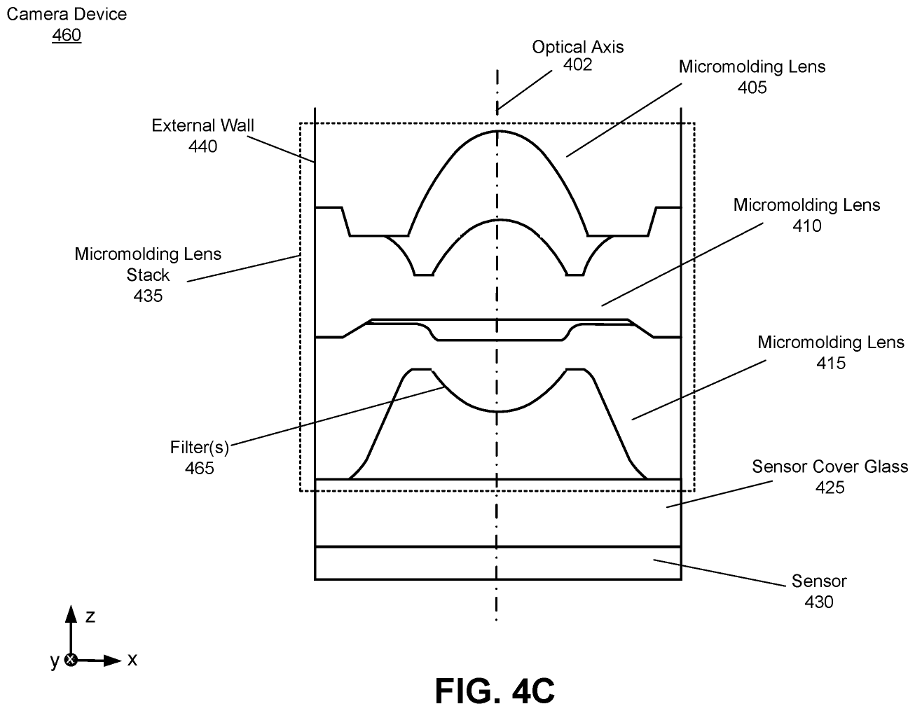

FIG. 4A is a cross section of a camera device 400 in an upward (vertical) posture, in accordance with one or more embodiments. The camera device 400 may capture data (e.g., one or more images) of a local area surrounding an electronic wearable device that integrates the camera device 400. The camera device 400 may be an embodiment of the camera device 115, an embodiment of the camera device 215, an embodiment of the camera device 217, an embodiment of the camera device 320, or an embodiment of the camera device 322. The camera device 400 includes a micromolding lens 405, a micromolding lens 410, a micromolding lens 415, a filter assembly 420, a sensor cover glass 425, and a sensor 430. The micromolding lenses 405, 410 and 415 may be positioned in optical series along an optical axis 402 and form a lens assembly with a micromolding lens stack 435. In one or more embodiments, the micromolding lens stack 435 includes only the micromolding lenses 405 and 410, i.e., in such cases, the micromolding lens 415 is not assembled within the micromolding lens stack 435 and the camera device 400. Each of the micromolding lenses 405, 410, 415 may be of a rectangular shape, cubic shape, round shape, prism shape, freeform shape, or some other shape. Hence, each of the micromolding lenses 405, 410, 415 may not be limited to a rectangular shape or cubic shape with 90 degrees angles between edges. Furthermore, each of the micromolding lenses 405, 410, 415 may be made of various suitable materials not limited to plastic or glass.

In some embodiments, the camera device 400 may also include a controller (not shown in FIG. 4A). In other embodiments, the controller may be part of some other system (e.g., a smartwatch or headset the camera device 400 is coupled to). In alternative configurations, different and/or additional components may be included in the camera device 400. The upward (vertical) posture of the camera device 400 corresponds to a posture of the camera device 400 where the optical axis 402 is substantially parallel to gravity (e.g., parallel to z axis in FIG. 4A). On the other hand, a forward (horizontal) posture of the camera device 400 corresponds to a posture of the camera device 400 where the optical axis 402 is substantially orthogonal to gravity (or parallel to x axis in FIG. 4A).

The micromolding lens stack 435 is a stationary structure that uses the micromolding lenses 405, 410 and 415 to focus light from a local area to a target area. The target area may include the sensor 430 for capturing the light from the local area. The micromolding lenses 405, 410 and 415 of the micromolding lens stack 435 may have a fixed (i.e., frozen) vertical position (e.g., along z direction). The micromolding lens 405 may include a side 406 and a side 407 that is opposite to the side 406, and the side 406 may include a mounting surface 408. The micromolding lens 410 may include a side 411 and a side 412 that is opposite to the side 411. The side 412 may include a mounting surface 413 that is directly affixed to the mounting surface 408 to form at least a portion of the micromolding lens stack 435 comprising the micromolding lens 405 and the micromolding lens 410 in optical series. The mounting surface 413 may be directly affixed to the mounting surface 408 via an interlocking mechanism of the mounting surface 413. Furthermore (e.g., to further enhance coupling between the micromolding lens 410 and the micromolding lens 405), an adhesive (e.g., glue) may be applied between the micromolding lens 405 and the micromolding lens 410, and not only limited to the mounting surface 413 with the interlocking mechanism. The micromolding lens 415 may include a side 416 and a side 417 that is opposite to the side 416. The side 417 may include a mounting surface 418 that is directly affixed to the mounting surface 413 to form the micromolding lens stack 435 comprising the micromolding lenses 405, 410, 415 in optical series. The mounting surface 418 may be directly affixed to the mounting surface 413 an interlocking mechanism of the mounting surface 418. Furthermore (e.g., to further enhance coupling between the micromolding lens 415 and the micromolding lens 410), an adhesive (e.g., glue) may be applied between the micromolding lens 410 and the micromolding lens 415, and not only limited to the mounting surface 418 with the interlocking mechanism.

In one or more embodiments, an external wall 440 of the micromolding lens stack 435 is coated with one or more protective coating layers. The one or more protective coating layers may include one or more layers of visible and near infrared non-transparent coating (e.g., black ink coating). The visible and near infrared non-transparent coating may be applied to the external wall 440 of the micromolding lens stack 435 to block undesired light (e.g., visible and near infrared light) from outside of the camera device 400 to propagate through the external wall 440 and reach components of the micromolding lens stack 435 causing stray light and/or flare. As the micromolding lens stack 435 is a self-supporting structure that does not include a lens barrel or lens holder, the function of lens barrel or lens holder in blocking the undesired light is instead performed by the one or more protective coating layers applied to the external wall 440 of the micromolding lens stack 435. Additionally, the one or more protective coating layers may include electro-magnetic interference (EMI) shielding coated on the external wall 440 of the micromolding lens stack 435. The EMI shielding may be applied to the external wall 440 of the micromolding lens stack 435 to protect internal components of the camera device 400 from electro-magnetic radiation from other components of an electronic device that integrates the camera device 400.

The micromolding lens stack 435 thus represents a self-supporting structure fixed in place within the camera device 400 that includes multiple micromolding lenses positioned in optical series and aligned along the optical axis 402. A corresponding interlock structure incorporated at each of the mounting surfaces 413 and 418 (i.e., lens flanges) may be employed to achieve a preferred level of lens centering and tilt control. An adhesive (e.g., glue) may be applied at each mounting surface 413, 418 to further enhance the corresponding interlock structure and affix the corresponding micromolding lens 410, 415 together within the micromolding lens stack 435. The micromolding lens stack 435 may be further affixed via an adhesive (e.g., glue) to a top side of the filter assembly 420. Alternatively, the camera device 400 may not include the filter assembly 420.

The filter assembly 420 may filter light coming from the micromolding lens stack 435 before reaching the sensor 430. The filter assembly 420 may include one or more filters, such as: an infrared cut-off filter (IRCF), an infrared pass filter (IRPF), one or more other color filters, a micro lens positioned over each pixel of the sensor 430, some other device for filtering light, or some combination thereof. The IRCF is a filter configured to block the infrared light and the ultraviolet light from the local area and propagate the visible light to the sensor 430; and the IRPF is a filter configured to block the visible light from the local area and propagate the infrared light and the ultraviolet light to the sensor 430. The filter assembly 420 may be placed on a top surface of the sensor cover glass 425. The sensor cover glass 425 may be placed on top of the sensor 430 to protect the sensor 430 from a pressing force generated from weights of the micromolding lens stack 435 and the filter assembly 420. The sensor cover glass 425 may be made of glass or some other suitable material that propagates light from the filter assembly 420 to the sensor 430.

The sensor 430 may detect light received by the camera device 400 from the local area that passes through the micromolding lenses 405, 410, 415 of the micromolding lens stack 435. The sensor 430 may also be referred to as an “image sensor.” The sensor 430 may be, e.g., a CMOS sensor, a CCD sensor, some other device for detecting light, or some combination thereof. Data (e.g., images) captured by the sensor 430 may be provided to a controller of the camera device 400 or to some other controller (e.g., image signal processor, not shown in FIG. 4A). The sensor 430 may include one or more individual sensors, e.g., a photodetector, a CMOS sensor, a CCD sensor, a pixel, some other device for detecting light, or some combination thereof. The individual sensors may be in an array. The sensor 430 may capture visible light and/or infrared light from the local area. The visible and/or infrared light may be focused from the local area to the sensor 430 via the micromolding lens stack 435. The sensor 430 may include various filters, such as an IRCF, IRPF, one or more other color filters, a micro lens on each pixel of the sensor 430, some other device for filtering light, or some combination thereof.

The controller of the camera device 400 (not shown in FIG. 4A) may control the components of the camera device 400. In some embodiments, the controller processes image data captured by the sensor 430. In some other embodiments, instead of the controller of the camera device 400, a different controller outside of the camera device 400 (e.g., image signal processor) is configured to process image data captured by the sensor 430.

The camera device 400 implemented as described above features advantages compared to camera devices implemented using the WLO lens technology or the micromolding lens technology. An advantage compared to the camera devices implemented using the WLO lens technology is that micromolding lenses 405, 410, 415 of the camera device 400 can be molded with significantly higher surface accuracy and better tolerances compared to lenses implemented using the WLO lens technology. An advantage compared to the camera devices implemented using the micromolding lens technology is that a lens barrel and lens holder are not utilized for supporting the micromolding lens stack 435 (i.e., the micromolding lens stack 435 is a self-supporting structure), which reduces dimensions of the camera device 400 along x axis and y axis.

FIG. 4B is an example cross section of a camera device 450 in the upward posture, in accordance with one or more embodiments. The camera device 450 includes the same components as the camera device 400 in FIG. 4A that are assembled in the same manner as described above in relation to FIG. 4A. One difference is that the camera device 450 includes the micromolding lens 415 having one or more lens foots 455 that are long enough to hold to the filter assembly 420, e.g., by one or more inner interlocks of the one or more lens foots 455. Hence, the filter assembly 420 may be effectively inserted at a bottom of the micromolding lens 415. Alternatively, the one or more lens foots 455 may be affixed via an adhesive (e.g., glue) to a surface of the filter assembly 420. In one or more embodiments, the filter assembly 420 is not assembled within the camera device 450. Instead, the sensor 430 may include one or more filters. In such cases, the one or more lens foots 455 of the micromolding lens 415 may be directly affixed via an adhesive (e.g., glue) to a surface of the sensor cover glass 425. As aforementioned in relation to the camera device 400 in FIG. 4A, an external wall 440 of the micromolding lens stack 435 may be coated with one or more protective coating layers, such as a visible and near infrared non-transparent coating layer (e.g., black ink coating) and/or EMI shielding (not shown in FIG. 4B). The camera device 450 may be an embodiment of the camera device 115, an embodiment of the camera device 215, an embodiment of the camera device 217, an embodiment of the camera device 320, or an embodiment of the camera device 322.

FIG. 4C is an example cross section of a camera device 460 in the upward posture, in accordance with one or more embodiments. The camera device 460 includes the same components as the camera device 400 in FIG. 4A that are assembled in the same manner as described above in relation to FIG. 4A. One difference is that, instead of the filter assembly 420, the camera device 460 in FIG. 4C includes one or more filters 465 coated on one of the micromolding lenses 405, 410, 415 (e.g., coated on a surface of the micromolding lens 415, as shown in FIG. 4C). The one or more filters 465 may include IRCF, IRPF, one or more other color filters, a micro lens positioned over each pixel of the sensor 430, some other device for filtering light, or some combination thereof. Alternatively, the one or more filters 465 may not be coated on any of the micromolding lenses 405, 410, 415. Instead, the sensor 430 may include one or more filters (e.g., IRCF, IRPF, one or more other color filters, a micro lens positioned over each pixel of the sensor 430, etc.). Alternatively, the one or more filters 465 may be coated on the sensor cover glass 425. Furthermore, as aforementioned in relation to the camera device 400 in FIG. 4A and the camera device 450 in FIG. 4B, an external wall 440 of the micromolding lens stack 435 may be coated with one or more protective coating layers, such as a visible and near infrared non-transparent coating layer (e.g., black ink coating) and/or EMI shielding (not shown in FIG. 4C). The camera device 450 may be an embodiment of the camera device 115, an embodiment of the camera device 215, an embodiment of the camera device 217, an embodiment of the camera device 320, or an embodiment of the camera device 322.

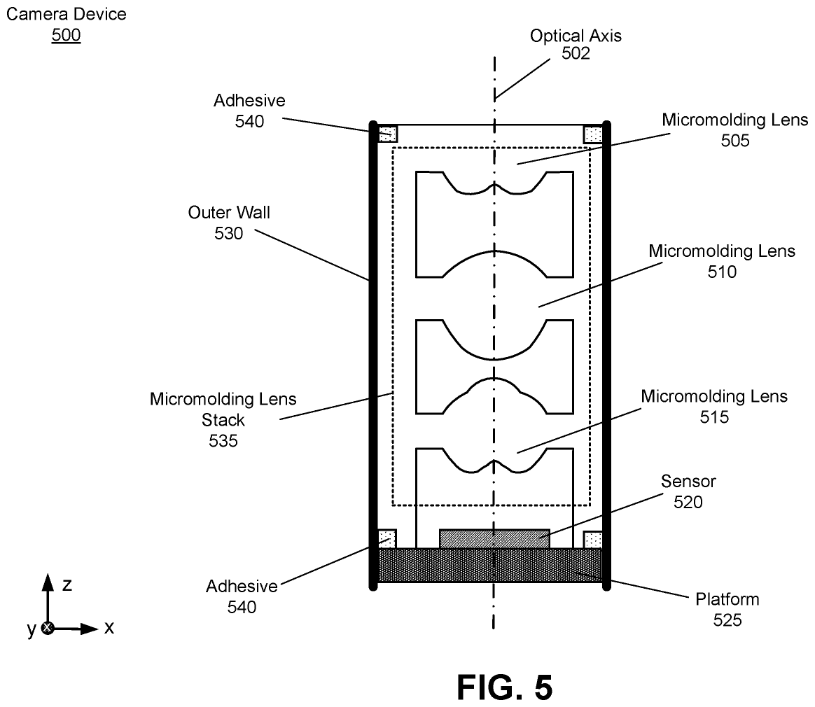

FIG. 5 is an example cross section of a barrel-less camera device 500 in the upward posture, in accordance with one or more embodiments. The camera device 500 may capture data (e.g., one or more images) of a local area surrounding an electronic wearable device that integrates the camera device 500. The camera device 500 may be an embodiment of the camera device 115, an embodiment of the camera device 215, an embodiment of the camera device 217, an embodiment of the camera device 320, or an embodiment of the camera device 322. The camera device 500 includes a micromolding lens 505, a micromolding lens 510, a micromolding lens 515, a sensor 520, a platform 525, and an outer wall 530 (i.e., external wall). The micromolding lenses 505, 510 and 515 may be positioned in optical series along an optical axis 502 and form a lens assembly with a micromolding lens stack 535. Each of the micromolding lenses 505, 510, 515 may be of a rectangular shape, cubic shape, round shape, prism shape, freeform shape, or some other shape. Hence, each of the micromolding lenses 505, 510, 515 may not be limited to a rectangular shape or cubic shape with 90 degrees angles between edges. Furthermore, each of the micromolding lenses 505, 510, 515 may be made of various suitable materials not limited to plastic or glass. The micromolding lens stack 535 is a self-supporting structure, i.e., no molded barrel, extruded sleeve, glass barrel or lens holder is utilized to support the micromolding lens stack 535 and align the micromolding lenses 505, 510, 515 within the micromolding lens stack 535. The micromolding lens stack 535 may have substantially the same structure and is assembled in the same manner as the micromolding lens stack 435 in FIGS. 4A-4C.

The sensor 520 may be an embodiment of the sensor 430 in FIGS. 4A-4C. The sensor 520 may be coupled and/or integrated into the platform 525. In some embodiments, a printed circuit board (PCB) may be also part of the platform 525. The sensor 520 may be coupled to the platform 525 such that the platform 525 is configured to move the sensor 520 in one or more directions relative to the optical axis 502. In some embodiments, one or more components (e.g., passive components, active components, etc.) may be recessed into a substrate (or placed on a same surface as the sensor 520) on the platform 525. The one or more recessed components may facilitate a reduction in form factor of the camera device 500 along z axis (i.e., parallel to the optical axis 502). For example, the z-height of the camera device 500 (i.e., height of the camera device along z axis) may be less than 2.10 mm.

The outer wall 530 at least partially encloses the components of the camera device 500, while including an aperture through which light may reach the micromolding lenses 505, 510, 515 of the micromolding lens stack 535. In some embodiments, the outer wall 530 may be rectangular-shaped. In alternative embodiments, the outer wall may be circular, square, hexagonal, or any other shape. In some embodiments, portions of the micromolding lens stack 535 may form at least a portion of the outer wall 530. In one or more embodiments, the outer wall 530 is coated with one or more protective coating layers. The one or more protective coating layers of the outer wall 530 may include a visible and near infrared non-transparent coating layer (e.g., black ink coating layer). Additionally, the one or more protective coating layers of the outer wall 530 may include EMI shielding. In one or more embodiments, the outer wall 530 is directly affixed to the components of the micromolding lens stack 535 via one or more adhesives 540 (e.g., one or more glues).

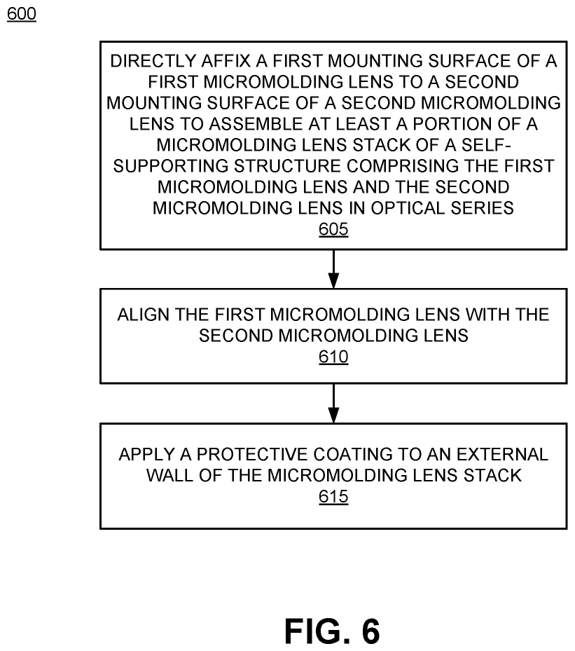

FIG. 6 is a flowchart illustrating a process 600 of assembling a camera device (e.g., the camera device 115, the camera device 215, the camera device 217, the camera device 320, the camera device 322, the camera device 400, the camera device 450, the camera device 460, or the camera device 500) without use of a barrel or lens holder, in accordance with one or more embodiments. Steps of the process 600 may be performed by one or more components of an assembly system. The camera device may be part of a smartwatch or some other wearable electronic device. Alternatively or additionally, the camera device is capable of being integrated into a DCA configured to determine depth information for one or more objects in a local area of the camera device. Embodiments may include different and/or additional steps of the process 600, or perform the steps of the process 600 in different orders.

The assembly system directly affixes 605 a first mounting surface of a first micromolding lens to a second mounting surface of a second micromolding lens to assemble at least a portion of a micromolding lens stack of a self-supporting structure comprising the first micromolding lens and the second micromolding lens in optical series. The first micromolding lens may include a first side and a second side that is opposite to the first side, and the first side may include the first mounting surface. The second micromolding lens may include a third side and a fourth side that is opposite to the third side, and the fourth side may include the second mounting surface. The assembly system may directly affix the second mounting surface to the first mounting surface via an interlocking mechanism of the second mounting surface. The assembly system may directly affix the second mounting surface to the first mounting surface further via an adhesive (e.g., glue). At least one of the first micromolding lens and the second micromolding lens may be of a round shape, a prism shape, or a freeform shape.

The assembly system may directly affix a third mounting surface of a third micromolding lens to the second mounting surface via an interlocking mechanism of the third mounting surface to form the micromolding lens stack comprising the first, second and third micromolding lenses in optical series. The third micromolding lens may include a fifth side and a sixth side that is opposite to the fifth side, and sixth side may include the third mounting surface. The assembly system may place an image sensor in optical series with the micromolding lens stack, wherein the image sensor is configured to detect light from the micromolding lens stack propagating along an optical axis of the micromolding lens stack. The assembly system may mount the micromolding lens stack on top of a glass cover of the image sensor.

The assembly system may place a filter element in optical series with the micromolding lens stack by coupling the filter element to the micromolding lens stack via an adhesive. The assembly system may place a filter element in optical series with the micromolding lens stack such that one or more foots of the third mounting surface hold the filter element to the lens stack (e.g., by one or more inner interlocks of the one or more foots). Alternatively, the assembly system may place a filter element in optical series with the micromolding lens stack such that the filter element is coated on the third micromolding lens.

The assembly system aligns 610 the first micromolding lens with the second micromolding lens. The assembly system may align the first micromolding lens with the second micromolding lens by applying an active alignment technique. The assembly system applies 615 a protective coating to an external wall of the micromolding lens stack. The protective coating may include a visible and near infrared non-transparent coating layer (e.g., black ink coating). Alternatively or additionally, the protective coating may include a layer of an electro-magnetic shielding material. The micromolding lens stack may be capable of being integrated into a camera device (e.g., the camera device 115, the camera device 215, the camera device 217, the camera device 320, the camera device 322, the camera device 400, the camera device 450, the camera device 460, or the camera device 500) without use of a lens barrel or a lens holder.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A lens assembly comprising:
a first micromolding lens including a first side and a second side that is opposite to the first side, the first side including a first mounting surface; and
a second micromolding lens including a third side and a fourth side that is opposite to the third side, the fourth side including a second mounting surface that is directly affixed to the first mounting surface to form at least a portion of a micromolding lens stack comprising the first micromolding lens and the second micromolding lens in optical series, the micromolding lens stack having a self-supporting structure.

2. The lens assembly of claim 1, wherein the second mounting surface is directly affixed to the first mounting surface via an interlocking mechanism of the second mounting surface.

3. The lens assembly of claim 2, wherein the second mounting surface is directly affixed to the first mounting surface further via an adhesive.

4. The lens assembly of claim 1, wherein the micromolding lens stack is capable of being integrated into a camera device without use of a lens barrel or a lens holder.

5. The lens assembly of claim 1, further comprising a filter element in optical series with the micromolding lens stack, wherein the micromolding lens stack is coupled to the filter element via an adhesive.

6. The lens assembly of claim 1, further comprising:
a third micromolding lens including a fifth side and a sixth side that is opposite to the fifth side, the sixth side including a third mounting surface that is directly affixed to the second mounting surface via an interlocking mechanism of the third mounting surface to form the micromolding lens stack comprising the first, second and third micromolding lenses in optical series.

7. The lens assembly of claim 6, further comprising a filter element in optical series with the micromolding lens stack, wherein the third mounting surface includes one or more foots holding the filter element to the lens stack.

8. The lens assembly of claim 6, further comprising a filter element in optical series with the micromolding lens stack, wherein the filter element is coated on the third micromolding lens.

9. The lens assembly of claim 1, wherein at least one of the first micromolding lens and the second micromolding lens is of a round shape, a prism shape, or a freeform shape.

10. The lens assembly of claim 1, wherein an external wall of the micromolding lens stack is coated with a visible and near infrared non-transparent coating layer.

11. The lens assembly of claim 1, an external wall of the micromolding lens stack is coated with one or more electro-magnetic interference shielding materials.

12. A camera device comprising:
a first micromolding lens including a first side and a second side that is opposite to the first side, the first side including a first mounting surface; and
a second micromolding lens including a third side and a fourth side that is opposite to the third side, the fourth side including a second mounting surface that is directly affixed to the first mounting surface to form at least a portion of a micromolding lens stack comprising the first micromolding lens and the second micromolding lens in optical series, wherein the micromolding lens stack is a self-supporting structure fixed in place within the camera device and positioned along an optical axis.

13. The camera device of claim 12, wherein the second mounting surface is directly affixed to the first mounting surface via an interlocking mechanism of the second mounting surface.

14. The camera device of claim 12, further comprising an image sensor in optical series with the micromolding lens stack, wherein the image sensor is configured to detect light from the micromolding lens stack propagating along an optical axis of the micromolding lens stack.

15. The camera device of claim 14, wherein the micromolding lens stack is mounted on top of a glass cover of the image sensor.

16. The camera device of claim 12, wherein the micromolding lens stack is fixed in place within the camera device without use of a lens barrel or a lens holder.

17. The camera device of claim 12, wherein the camera device is capable of being integrated into a depth camera assembly configured to determine depth information for one or more objects in a local area.

18. A method comprising:
directly affixing a first mounting surface of a first micromolding lens to a second mounting surface of a second micromolding lens to assemble at least a portion of a micromolding lens stack of a self-supporting structure comprising the first micromolding lens and the second micromolding lens in optical series, the first micromolding lens including a first side and a second side that is opposite to the first side, the first side including the first mounting surface, the second micromolding lens including a third side and a fourth side that is opposite to the third side, the fourth side including the second mounting surface;
aligning the first micromolding lens with the second micromolding lens; and
applying a protective coating to an external wall of the micromolding lens stack.

19. The method of claim 18, wherein aligning the first micromolding lens with the second micromolding lens comprises aligning the first micromolding lens with the second micromolding lens by applying an active alignment technique.

20. The method of claim 18, wherein applying the protective coating comprises:
applying a visible and near infrared non-transparent coating layer to the external wall of the micromolding lens stack; and
applying a layer of electro-magnetic shielding material to the external wall of the micromolding lens stack.
